(19) United States
(12) Patent Application Publication
(10) Pub. No.: US 2006/0126457 A1
(43) Pub. Date: Jun. 15, 2006

(54) Three-dimensional information recording and reading method

(76) Inventors: Takeshi Maeda, Koganei (JP); Shigeharu Kimura, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/063,641

(22) Filed: Feb. 24, 2005

(30) Foreign Application Priority Data
Dec. 15, 2004 (JP) 2004-363038

(51) Int. Cl. G11B 7/00

(52) U.S. Cl. 369/44.37; 369/112.01

(57) ABSTRACT

The three-dimensional information reading/recording method of this invention enhances the recording capacity as well as performs high-speed reading/recording of information three-dimensionally. The method includes: forming three-dimensional lattices in a three-dimensional optical disk, disposing to wobble the lattices in a plane perpendicular to the traveling direction of light spots, generating signals for controlling the light spots, and scanning at least one light spot between the lattices three-dimensionally to thereby read out and record the information.

The present application claims priority from Japanese application JP 2004-363038 filed on Dec. 15, 2004, the content of which is hereby incorporated by reference into this application.

### FIELD OF THE INVENTION

The present invention relates to a method of reading/writing information three-dimensionally to/from media by using optical characteristics and a device of the same. =cl BACKGROUND OF THE INVENTION

The international academic society ISOM2003 has recently released two methods of recording information to media in the three-dimensional directions. Both are the method of recording information in the three-dimensional directions, which expands the currently primary recording method for an optical disk that records information in one layer to associate each bit with one mark, to the thickness direction of the disk.

[Non-Patent Document 1] “Bit-Wise Volumetric Optical Memory Utilizing Two-Photon Absorption in Aluminum Oxide Medium” Technical Digest of International Symposium on Optical Memory 2003, We-E-04

[Non-Patent Document 2] “Mechanism of Recording on Electro-chromic Information Layers of Multi-Information-Layer”, Technical Digest of International Symposium on Optical Memory 2003, We-E-05

The above release discloses the theoretical operation of reading/writing information; however it does not describe the detailed means that locates light spots three-dimensionally to read/write information, which is essential for developing the three-dimensional recording into practical use. In order to develop the three-dimensional recording into practical use, the means of reading/writing information including the positioning of the light spots should conform to the mass production of optical disks. The traditional method does not provide any special marks for detecting the focus in the direction perpendicular to the two-dimensional plane (the optical axis direction of an objective lens mounted on an optical pickup) in the positioning of the light spots on the two-dimensional plane, and detects the state of just focus by observing the state of light beams returned to the optical pickup. This is because there is only one recording layer and it is possible to determine whether the light spots are of just focus in the recording layer from the state of reflected light beams. However, to store information in the optical axis direction, it becomes necessary to detect the positions of the light spots in the optical axis direction with high precision. It is also necessary at the same time to detect the positions of the light spots in the direction (radial direction of the track) perpendicular to the direction that the light spots travel in the two-dimensional plane (circumferential direction of the track), which is the same as the traditional method. The traditional method has not shown any special consideration for detecting the position in the focus direction, although a guide groove or a special mark group has been used for detecting the position in the radial direction of the track.

Further, the traditional three-dimensional recording can be regarded as an expansion of the one-layer recording in the two-dimensional plane to a multi-layer recording. Since it performs reading/writing by each layer, the traditional three-dimensional recording requires the same reading/writing time of information as the conventional one-layer recording, and it is incapable of shortening the time for reading/writing information to match with the increase of storage information by multi-layers.

### SUMMARY OF THE INVENTION

The present invention provides a method of rapidly reading/writing information to meet the increasing trend of storage information, in the method of recording information three-dimensionally to associate information bits with marks.

As the overall construction, the three-dimensional information reading/recording method of this invention includes: providing three-dimensionally control areas for guiding minute light spots by which information is recorded and read out in a three-dimensional optical disk, positioning the minute light spots in the three-dimensional directions by using the control areas embedded in the three-dimensional optical disk, providing between the control areas an information recording area for reading/recording information in the three-dimensional directions, and recording and reading out the information three-dimensionally. While the light spots travel in the three-dimensional optical disk, this method is made capable of generating light spot control signals in the two directions perpendicular to the traveling directions of the light spots from the control areas, and controls the positions of the light spots by using the control signals.

In the control areas are formed marks along the traveling directions of the light spots, which have a three-dimensional structure and are disposed offset in different directions each other in a two-dimensional plane perpendicular to the traveling directions, and a mark line is formed to spirally advance to the traveling directions of the light spots. A focus error signal and a tracking error signal are detected in the control areas. A continuous mark line is made to have a structure that wobbles to both of the two wobbling directions being orthogonal to each other, so that the mark line draws a spiral to the traveling directions of the light spots.

The information recording area is provided in a three-dimensional space between the control areas, and the information is recorded in this information recording area as an information recording block. In order to record information three-dimensionally, at least one light spot is scanned three-dimensionally in the information recording area, and the information is recorded. Further, the method may be arranged to scan plural light spots in the depth direction of the disk in the information recording area, and to record the information. Further, the method records and reads out information in the information recording area by combining the operation that varies a wave-front of an incident light on an objective lens by a light from a light source according to the information two-dimensionally and the operation that varies the same wave-front one-dimensionally.

According to this invention, it is possible to read out and record mass information in a shorter time, in a three-dimensional optical disk having a guide track for positioning the light spots in the three-dimensional directions.

### BRIEF DESCRIPTION OF THE DRAWINGS

FIG. 1 is a schematic diagram illustrating a first embodiment of the three-dimensional reading/writing device according to the present invention;

FIG. 2 is a typical chart illustrating the relation of the information track set in a three-dimensional optical disk and light spots;

FIG. 3 is a detailed diagram of the read/write circuit in FIG. 1;

FIG. 4 is a schematic diagram illustrating a second embodiment of the three-dimensional reading/writing device according to the present invention;

FIG. 5 is a detailed diagram of the read/write circuit in FIG. 4;

FIG. 6 is a schematic diagram illustrating a third embodiment of the three-dimensional reading/writing device according to the present invention;

FIG. 7 is a projection diagram of a spiral line;

FIGS. 8A to 8D explain the operation of a control signal detection circuit according to the present invention;

FIGS. 9A and 9B are explanatory charts of a signal detected by a mark;

FIG. 10 is a typical chart illustrating waveforms detected by a mark;

FIGS. 11A to 11C explain a method of forming a three-dimensional lattice;

FIG. 12 is a schematic diagram illustrating the intensity distribution of a three-dimensional lattice;

FIGS. 13A and 13B illustrate the intensity distribution of a three-dimensional lattice, viewed from a section;

FIG. 14 is an explanatory chart of a wobbled mark group;

FIG. 15 is a chart illustrating the relation between a three-dimensional recording area and a control area;

FIG. 16 is an explanatory chart of the three-dimensional recording area;

FIG. 17 is another explanatory chart of the three-dimensional recording area;

FIGS. 18A to 18C explain a device for forming the three-dimensional lattice;

FIG. 19 is an explanatory chart of the recording method using a two-dimensional arrayed light source;

FIG. 20 is a schematic diagram illustrating a fourth embodiment of the three-dimensional reading/writing device according to the present invention;

FIG. 21 is a detailed diagram of the read/write circuit in FIG. 20;

FIG. 22 is a schematic diagram of a digital mirror;

FIG. 23 is a structural chart of a digital mirror;

FIG. 24 is a schematic diagram illustrating a fifth embodiment of the three-dimensional reading/writing device according to the present invention;

FIGS. 25A and 25B explain an arrayed light source;

FIG. 26 illustrates a structure of a three-dimensional optical disk;

FIGS. 27A and 27B are sectional views of a synchronous interference pattern; and

FIG. 28 is an explanatory chart of a rod-like mark.

### DETAILED DESCRIPTION OF THE PREFERRED EMBODIMENTS

The preferred embodiments of the present invention will be described with reference to the accompanying drawings. In the following drawings, the parts having the same functions are given the same numeric symbols to avoid the repeated descriptions.

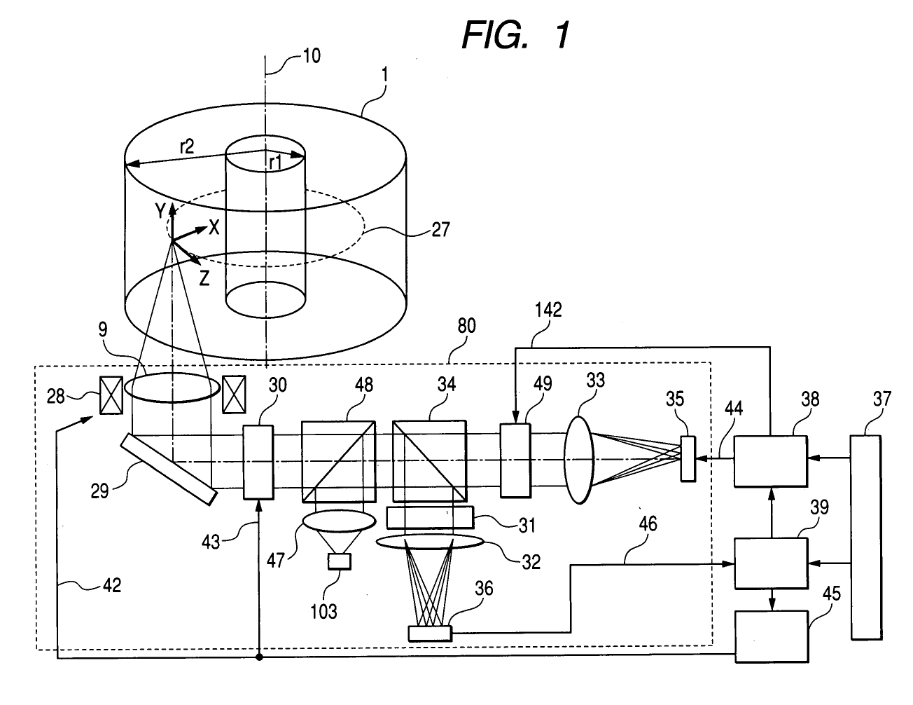

FIG. 1 is a schematic diagram illustrating a first embodiment of the three-dimensional reading/writing device according to the present invention, which uses a three-dimensional optical disk as a recording medium. A three-dimensional optical disk 1 that records information three-dimensionally assumes a columnar form, has a virtual rotation center 10, and has a hollow part from the center 10 to an inner circumference r1 and a recording area from the inner circumference r1 to an outer circumference r2 where information is recorded. To read/write information needs to engage this columnar body with a hub of the radius r1 and to make a motor rotate this with the virtual rotation center 10 as the center. The access control to the recording area of the three-dimensional optical disk by light spots generated by an optical pickup 80 is performed from the three directions of the circumferential direction, radial direction, and thickness direction of the columnar body.

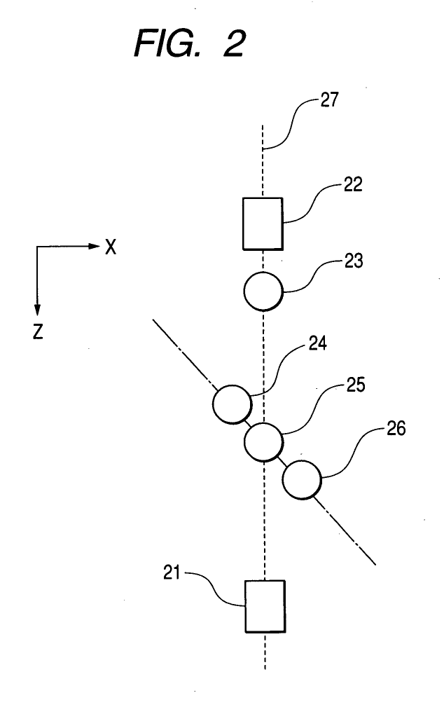

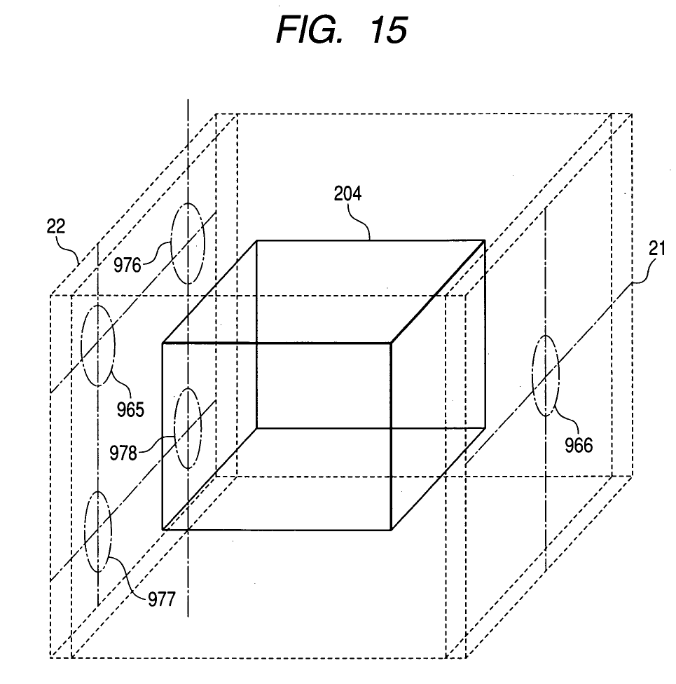

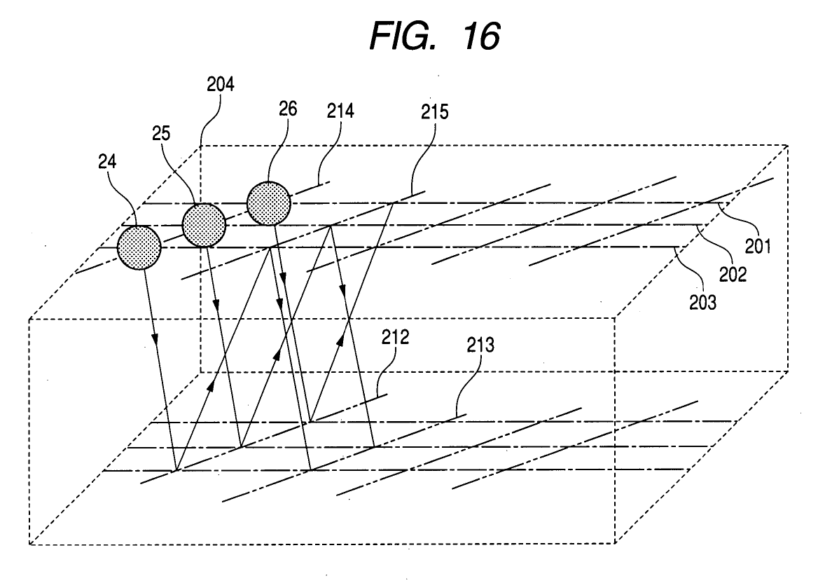

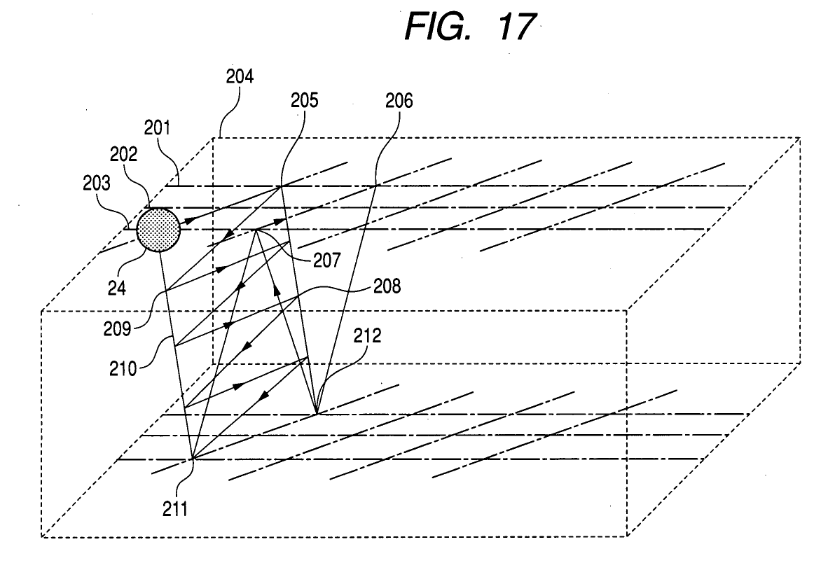

The operation of the reading/writing will be described in detail. FIG. 2 is a typical chart illustrating the relation of an information track 27 set in the three-dimensional optical disk 1 and the light spots. The principle of reading/writing information will be described with FIG. 15, which performs the positioning of the light spots by the marks formed in a control area in advance. The information is read or written in an information recording area 204 as one block, located in a three-dimensional space between two adjoining control areas 21 and 22 along the information track 27. There are several methods of recording information in the information recording area 204. One of them is shown in FIG. 16, and this method records information three-dimensionally by scanning plural light spots 24, 25, and 26 relatively in the circumferential direction according to the rotation of the disk as well as in the optical axis direction, and by recording the marks at the lattice points of the three-dimensional lattice set in the information recording area 204 while independently turning on and off the light spots 24, 25, and 26 according to the recording information. Another method is shown in FIG. 17, and this method records information three-dimensionally by scanning at least one light spot 24 along the arrow in the information recording area 204, and by recording the marks at the lattice points of the three-dimensional lattice set in the information recording area 204 while independently turning on and off the light spots 24, 25, and 26 according to the recording information. FIG. 1 shows the embodiment of the reading/writing method using the three-dimensional recording area illustrated in FIG. 16.

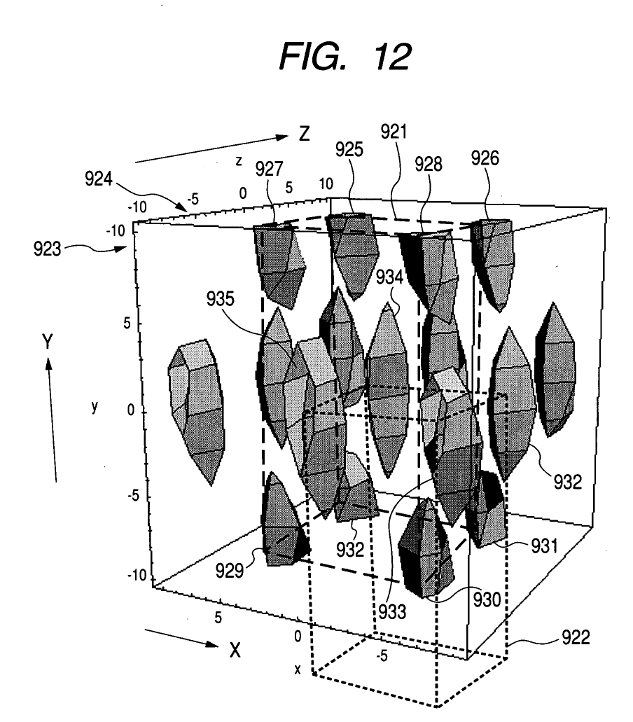

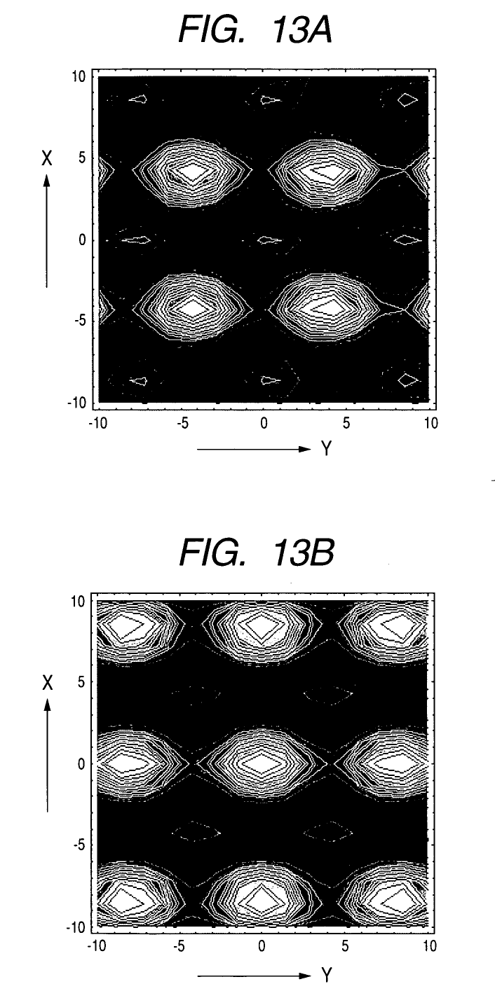

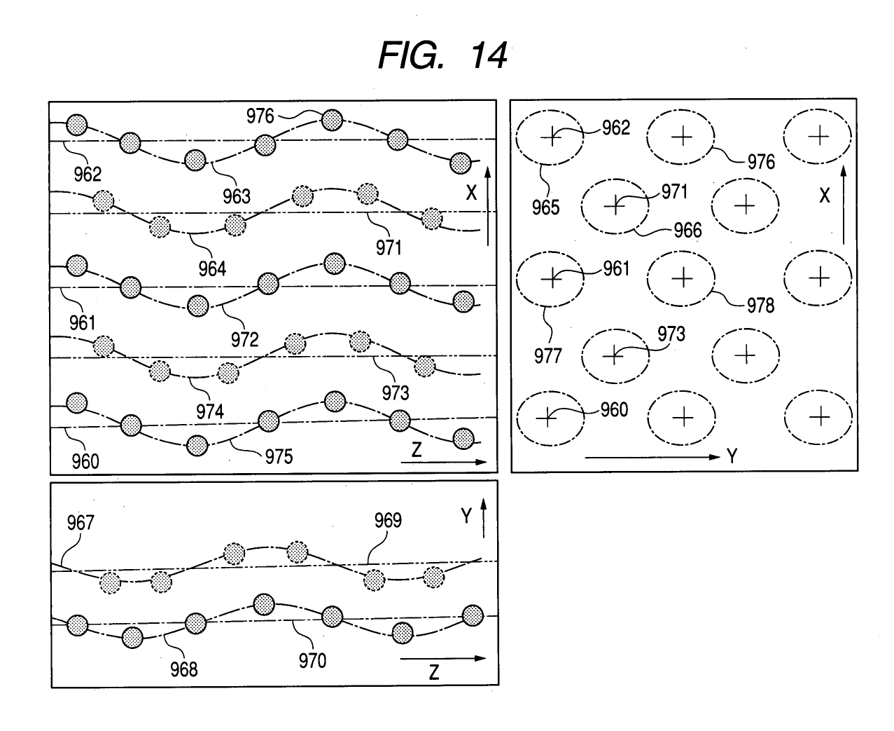

In FIG. 1, a light source 35 of plural point sources emits beams of light, and a coupling lens 33 transforms the beams into a parallel beam of light. The parallel beam penetrates through a prism 34 and an optical element 30 for compensating the aberration. A reflective mirror 29 bends the parallel beam so as to make the beam advance upward along a bended optical path, and the beam penetrates an objective lens 9 to form light spots 23, 24, 25, and 26 in an optical disk 1. Another light source 103 has a different wavelength from that of the former light source, and a coupling lens 47 collimates the beams from the light source 103. A prism 48 makes the optical path of a collimated beam coincide with that of the former, and the objective lens 9 concentrates the collimated beam in the disk 1. The light spot 23 is positioned on the information track 27 as a control spot. The information track 27 is provided with control areas 21 and 22 for detecting control information that control the light spots. The control areas 21 and 22 are formed with a mark group, which will be described later with FIG. 12, FIG. 13, FIG. 14, and FIG. 15. The light spot 23 is used for tracking the information track 27. The light spots 23, 24, 25, and 26 are used for forming and reading a recording mark. The exposure is reduced in the readout so as not to destroy recorded data.

The reflected light from the information track 27 penetrate through the objective lens 9, the reflective mirror 29, and the optical element 30, and the prism 34 bends the optical path downward. The bent light penetrates through an optical filter 31, and a condensing lens 32 condenses the light on an optical detector 36. A photo-electric current 46 is inputted to a readout circuit 39, where control information and clocks are detected. The readout circuit 39 generates a signal 44 for a record circuit 38 to modulate the light source 35 according to the clock used for detecting user information sent from a host controller 37, and the record circuit 38 performs the intensity modulation to the light spots 24, 25, and 26 each in the disk 1. And, the control information and address information detected from the readout circuit 39 are inputted to an access control circuit 45. The access control circuit 45 generates a signal 42 that drives a two-dimensional actuator 28 for the objective lens 9 and a signal 43 that drives the optical element 30 for compensating the aberration. In general, the objective lens is designed in a manner that the best performance thereof is attained on a plane being at a specified depth from the substrate surface of the disk 1. Accordingly, to make the focus position deviate in the depth direction of the substrate will increase the spherical aberration of the optical system, so that the image of the spot will be distorted at the focus position. The optical element 30 for compensating the aberration is to compensate the spherical aberration according to the focus position. One of the simplest constructions for the optical element for compensating the aberration employs a combination of plural lenses, varies the distances between the lenses, and thereby varies the divergent and convergent angles that fall on the objective lens. Another one, using a liquid crystal element, delays or advances the phase of the light wave to partially vary the wave front of the light beam, and thereby compensates the aberration.

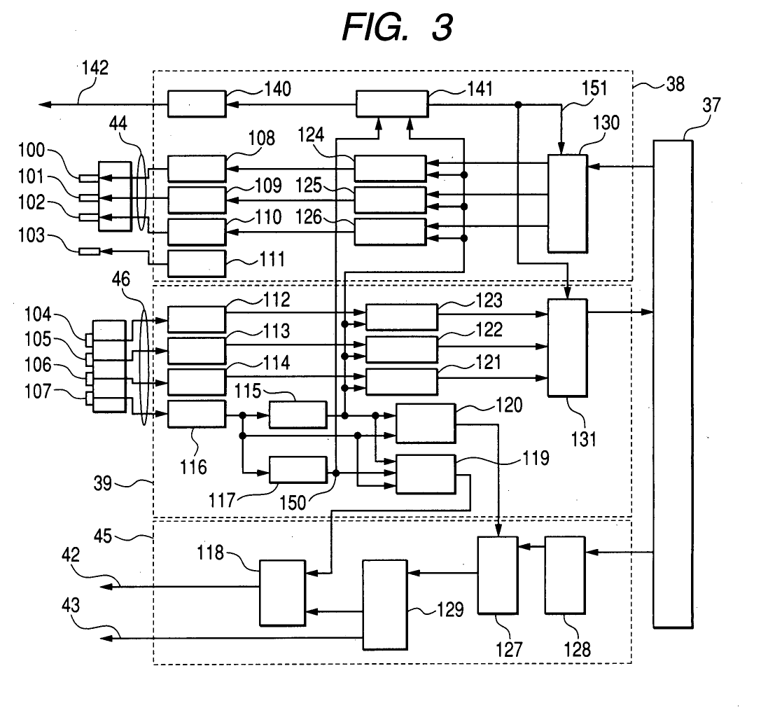

The operation of the read/write circuit will be described in detail with FIG. 3. The light source 35 is made up with plural light sources, for example, semiconductor lasers 100, 101, 102, and 103. The light from these light sources are condensed into the light spots 26, 25, 24, and 23 in the disk 1. Therefore, to locate the position of the light spot 23 will automatically determine the positions of the other light spots 24, 25, and 26 with a specified interval. The beams emitted from the light sources 100, 101, and 102, being collimated by the coupling lens 33, penetrate through an optical element 49 that moves the light spots 24, 25, and 26 in the optical axis direction (that adds parabolically inflected modulations to the wave fronts and varies the focus positions of the focused light spots along the optical axis), and the objective lens 9 condenses the beams in the disk 1. The light source 103 is supplied with a dc current through a driver circuit 111 so as to irradiate a constant amount of light. The light beams emitted from the light source 103 are reflected on the disk, and are condensed by a light receiver 107 mounted on the optical detector 36. The photo-electric current 46 is converted into a voltage by a preamplifier 116, which is inputted to a clock generation circuit 115, a data discrimination circuit 120, and an area detection circuit 117.

The area detection circuit 117 detects the control areas 21 and 22 while discriminating them from other areas, and inputs a signal 150 indicating the control area to a circuit 119 for generating control information. The circuit 119 generates a track error signal and a focus error signal, which will be described latter, and these signals are inputted to a drive circuit 118 that drives the two-dimensional actuator 28. On the other hand, the data discrimination circuit 120 detects a track address signal, which is inputted to a circuit 127 for comparing address information. The circuit 127 compares the above track address signal and a signal outputted from a register 128 that temporarily stores address orders from the host controller 37. A circuit 129 for generating signals that control the light spots sends out the signal for controlling and driving the two-dimensional actuator 28 to the drive circuit 118, and sends out the signal 43 for compensating the aberration caused by the movement of the actuator 28.

A register 130 receives the user data sent out from the host controller 37, and stores the data as the three-dimensional information. The three-dimensional information is inputted to modulation circuits 124, 125, and 126, which modulate the information with the output signal from the clock generation circuit 115. The modulated information is inputted to laser drive circuits 108, 109, and 110, each of which performs the intensity modulation to the light sources 100, 101, and 102.

The reading/writing operation of the information will further be described with FIG. 16. The optical element 49 moves the light spots 24, 25, and 26 in the optical axis direction, and arrays the three light spots on a line 214 to scan the light spots in the optical axis direction. As the spots reach a line 212, they are made to return to a turn back line 215, and this operation is repeated. That is, the plural spots are scanned in the circumferential direction relatively with the rotation of the disk, and are scanned at the same time in the optical axis direction. During the scanning, the intensity modulation is performed to the light sources of the plural spots to record the data in the three-dimensional area. Thus, the data are recorded with a predetermined interval in the three-dimensional information recording area 204 as one unit, which is located between the control areas of the information track 27 in the three-dimensional optical disk. To perform this recording, the register 130 stores the data of the three light spots arrayed on the line 214 as one set at a specific timing, and the register retains these sets of data at each time of scanning.

According to the aforementioned construction, the spot 23 detects the focus error signal, tracking error signal, and address signal in a control signal detection area to thereby follow the track center that meanders due to the eccentricity and runout of the disk. On the other hand, the spots 24, 25, and 26 scan in an area offset three-dimensionally relatively from the track center that the spot 23 traces, to read/write information.

A scanning control circuit 141 for controlling the scanning of the light spots receives the signal 150 indicating the control area and the clock signal, and generates drive waveforms for scanning the spots in the focus direction. The scanning control circuit 141 sends out the drive waveforms to a drive circuit 140, and at the same time sends out a timing signal 151 indicating the breakpoint of a pair of data to be read or written synchronously with the drive waveform to the registers 130 and 131. The register 130 outputs a pair of recorded data to the modulation circuits 124, 125, and 126 in parallel.

While the spot 23 is positioned on the information track 27, and the spots 24, 25, and 26 are arranged on the recorded information recording area 204, the recorded data are scanned by the optical element 49 according to the drive waveform from the scanning control circuit 141, and the reflected light beams each are condensed by the receivers 104, 105, and 106 mounted on the optical detector 36. The photo-electric currents each are converted into voltages by the preamplifiers 112, 113, and 114. The data discrimination circuits 123, 122, and 121 detect and demodulate the above converted voltages based on the clock generated by the clock generation circuit 115, and the results are sent to the register 131. The register 131 stores pairs of data outputted in parallel from the data discrimination circuits 123, 122, and 121 according to the timing signal 151 as the three-dimensional data at each time of scanning. The register 131 transforms the format of the stored data into that of the user data before sending out the data to the host controller 37.

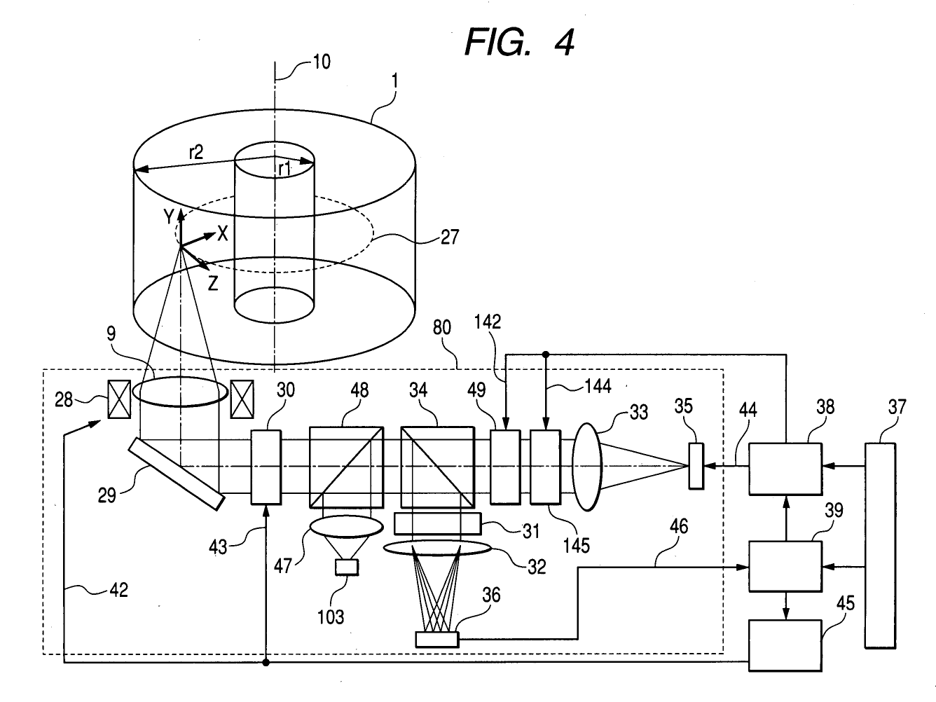

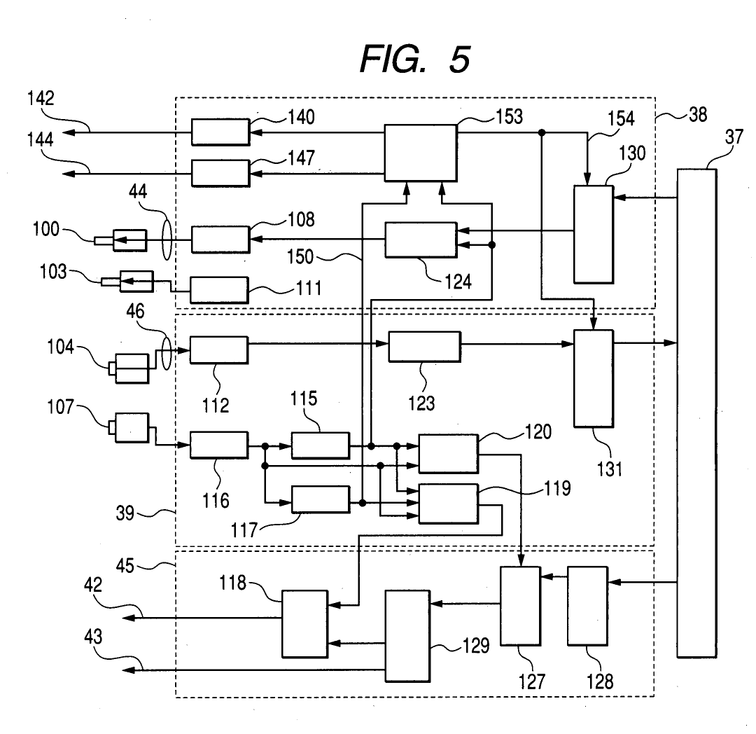

FIG. 4 and FIG. 5 show the embodiment of the reading/writing method using the three-dimensional recording area illustrated in FIG. 17. This method scans at least one spot 24 in the information recording area 204 along the arrow, as shown in FIG. 17, and records information in the information recording area 204. The optical system in FIG. 4 adds an optical deflector 145 to the optical system in FIG. 1, which deflects the spots in the track direction by deflecting the emission angle of the light beams. Further in FIG. 5, the light sources 101 and 102 and the receivers 105 and 106 residing in FIG. 3 are eliminated, and a scanning control circuit 153 is provided instead of the scanning control circuit 141, which scans the spot 24 wherein the light beam from the light source 100 is condensed, three-dimensionally in the information recording area 204.

In the above embodiment, the user data sent out from the host controller 37 are stored in the register 130. The scanning control circuit 153, receiving the clock signal and the signal 150 indicating the control area, moves the spot 24 to a point 205 in FIG. 17 by controlling the rotation speed of the disk and a signal 144 for deflecting the optical deflector 145. Thereafter, by controlling the optical element 49 that moves the light spot 24 in the optical axis direction, the scanning control circuit 153 moves the spot 24 to a point 209. Next, the circuit repeats the scanning in the radial direction of the disk and in the optical axis direction; as it reaches a point 212, the scanning returns to a point 207, and the same scanning is repeated. Thus, the mark is recorded according to the recording information at a lattice point of the three-dimensional lattice that has been set in the information recording area 204 in this manner, whereby the three-dimensional information recording can be performed.

The scanning control circuit 153 outputs a signal for controlling the spot in the radial direction of the disk, which is inputted to a drive circuit 147. The drive circuit 147 outputs the signal 144 for deflecting the optical deflector 145. The scanning control circuit 153 also outputs a signal for controlling the spot in the optical axis direction, which is inputted to the drive circuit 140. The drive circuit 140 outputs a signal 142 for driving the optical element 49 that moves the light spot 24 in the optical axis direction. Further, the scanning control circuit 153 outputs a timing signal 154 for reading/writing data, which is inputted to the register 130 and register 131. The register 130 outputs the recorded data to the modulation circuit 124 synchronously with the scanning timing. During the readout, the amount of light that irradiates each spot is reduced compared to that during the recording, to such a degree as not destroying the recorded data. During the readout, the read data experiencing the data discrimination are stored in the register 131 synchronously with the scanning timing.

In addition to the areas 21 and 22 for detecting the control information, the information track 27 includes an area for detecting the address information representing that the track concerned corresponds to which track in the depth direction of the disk, and to which position in the radial direction. The address information can be given by the array pattern of the unit mark described later. And, a mark pattern having a specific interval is inserted to generate the clock.

If the wavelength of the light source 103 emitting the light spot for tracking is designed to be different from that of the light source 100 emitting the light spot for recording the mark, it will avoid that the recording affects the detection of the control signal. Since the filter 31 penetrates only the light with a specific wavelength, it is possible to penetrate only the light from the light source 103, to detect the positioning signal without being affected by the light source 100 during the recording, and to make the guide mark follow the spot 23. This filter 31 can also be used as an optical element that permits a specific wavelength to penetrate through, since it detects luminescence with a wavelength different from a readout wavelength as a three-dimensional recording material having the two-photon absorption function.

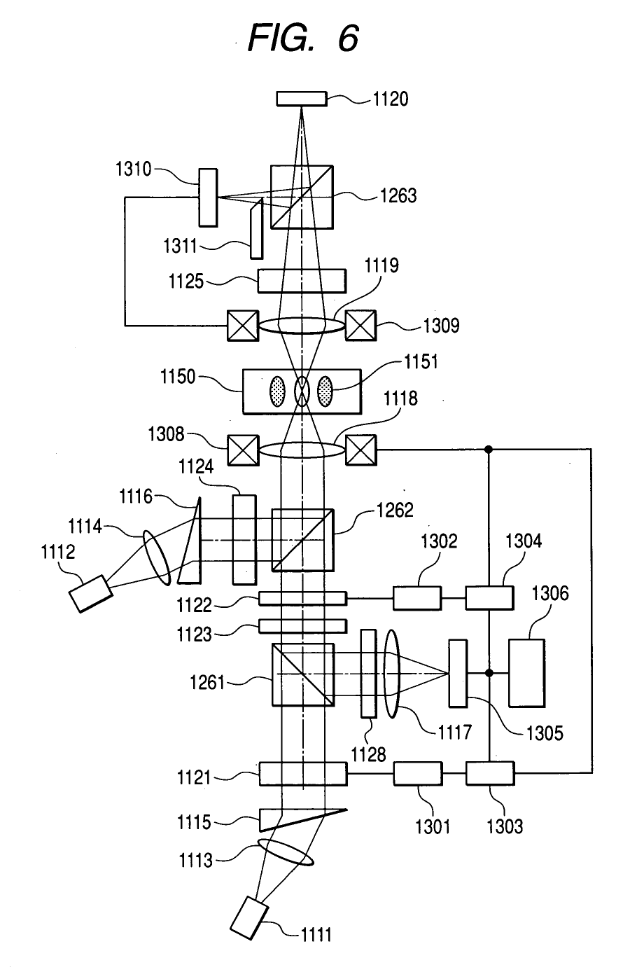

There is another embodiment as a readout optical system using the two-photon absorption, which is illustrated in FIG. 6. A semiconductor laser 1111 emits a laser beam with a wavelength λ1 for reading. A collimator lens 1113 and a triangle prism 1115 transform the beam into a circularly collimated beam. This collimated beam penetrates through an optical axis direction modulator 1121 driven by a drive circuit 1301, where the beam has a parabolically inflected modulation added to the wave front. The optical-axis-direction modulator 1121 is installed to vary the focus position of the focused spot along the optical axis. After penetrating through a dichroic mirror 1261, the beam with the wavelength λ1 penetrates through a spherical aberration compensator 1123 and a radial direction modulator 1122. The spherical aberration compensator is to compensate a spherical aberration caused by a variation in the depth of a recorded bit 1151 written in a medium 1150 from the surface thereof. The spherical aberration compensator is made up with a combination of a concave lens and a convex lens, which compensates the spherical aberration by adjusting the distance between both the lenses. The radial direction modulator 1122 is driven by a drive circuit 1302, which deflects the condensed position of the beam to the direction perpendicular to the optical axis, namely, to the radial direction of the medium. The beam penetrating through a dichroic mirror 1262 irradiates the recorded bit 1151 with a light spot of a minute diameter through an objective lens 1118. A signal light beam with a wavelength □3 is emitted from the recorded bit 1151. This light is a non-linear light, not a coherent light, and does not have directivity. Apart of this light is condensed by the objective lens 1118, and is reflected by the dichroic mirror 1261; thereafter, the light penetrates through a filter 1128 and a lens 1117, and falls on an optical detector 1305. The filter 1128 has the characteristic that permits only the light beam with the wavelength λ3 to penetrate through. A signal from the optical detector 1305 is processed into a data signal by an electronic circuit 1306.

The recorded bit 1151 is recorded in a disk-form medium, and is read out from a rotating medium; therefore, the tracking technique becomes necessary which makes the recorded bit string follow the light spot. The tracking and focusing will be described later, and the circuitry necessary for the signal processing will be described here. The signal from the optical detector 1305 is multiplied by a signal from an oscillator 1301 in a multiplier 1303, and it is also multiplied by a signal from an oscillator 1302 in a multiplier 1304. The multiplier 1303 produces a focus error signal in the optical axis direction, and the multiplier 1304 produces a tracking error signal in the radial direction. An actuator 1308 moves the objective lens 1118 in the optical axis direction and the radial direction so as to decrease these error signals, thus performing the tracking.

The light beam with the wavelength λ3 is emitted also in the direction that the irradiated light travels. A construction that makes the light in this direction return to the optical detector 1305 will enhance the detection efficiency. The non-linear light emitted in the traveling direction of the irradiated light penetrates through a condensing lens 1119, a spherical aberration compensator 1125, and a half mirror 1263, thus converging on a reflective mirror 1120. A part of the reflected light by the reflective mirror 1120 is reflected by the half mirror 1263, which is detected by a bi-cell detector 1310. A knife edge 1311 is placed on the way of the optical path in order to attain the focus error signal, which interrupts half of the optical path. The focus error signal can be attained from the bi-cell detector 1310. The focus error signal controls the actuator 1309 capable of making the condensing lens 1119 move in the optical axis direction, so that the spot on the reflective mirror 1120 can be maintained at aminimum size. The minimum spot position of the light beam with the wavelength λ1 by the objective lens 1118 and the spot position on the reflection plane of the reflective mirror 1120 are in the conjugate relationship with regard to the condensing lens 1119. Accordingly, the non-linear light reflected on the reflective mirror 1120 can return to the minimum spot position in the objective lens 1118, and penetrating through the objective lens 1118, it can also fall on the optical detector 1305.

Further, the irradiated light having penetrated through the medium is reflected on the reflective mirror 1120, which makes it possible to irradiate the same recorded bit from the opposite direction, and makes it possible to emit the non-linear light again. Owing to these effects, the non-linear light detected by the optical detector 1305 increases, thus enhancing the signal-to-noise ratio.

A semiconductor laser 1112 emits a laser beam with a wavelength λ2 for writing. A collimator lens 1114 and a triangle prism 1116 transform the beam into a circularly collimated beam. The numeric symbol 1124 signifies a spherical aberration compensator, which is used when the aberration cannot completely be compensated by the spherical aberration compensator 1123. The laser beam for writing is reflected by the dichroic mirror 1262, and the reflected beam is focused in the medium by the objective lens 1118.

In order to perform the above three-dimensional access by irradiating the light spot to the three-dimensional disk, a virtual guide track for guiding the light spot becomes necessary. This virtual guide track 27 is formed into a substantially concentric tube along the circumferential direction of the three-dimensional disk. This tube necessarily takes any one of the following forms: a form being closed in a plane perpendicular to the depth direction of the three-dimensional disk, a form being not closed but continuous from the inner circumference to the outer circumference or from the outer to the inner in the same plane, or a form being not closed in the same plane but joining continuously to the depth direction of the three-dimensional disk.

In order to guide the spot into the above guide track, it is necessary to provide an area in which the information indicating the position of the track is recorded, continuously at an equal interval. The control signal for positioning the light spot can be detected from this area. This signal includes signals that indicate the displacements of the spot and the guide track, to the two directions perpendicular to the traveling direction of the light spot, namely, the circumferential direction of the three-dimensional disk 1. Hereunder, these signals are named as the focus error signal to the depth direction of the disk and the track error signal to the radial direction of the disk.

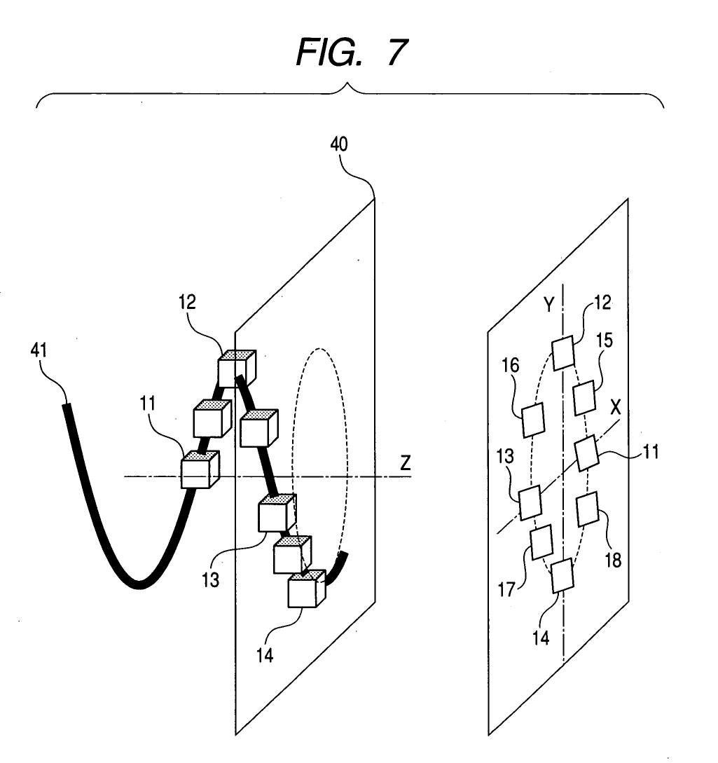

The operational principle of this invention will be described with FIG. 7. Plural marks are disposed in the directions X and Y perpendicular to the traveling direction Z of the light spot. Here, a mark string will be introduced which is composed of eight marks 11, 12, 13, 14, 15, 16, 17, and 18. These eight marks have the same shape, but have the different positions. These positions are projected on a plane 40 perpendicular to the traveling direction Z of the light spot. When the projected positions of the marks are expressed in this plane by means of the coordinate perpendicular to the depth direction Y of the disk and the radial direction X of the disk, each of the marks is positioned on a spiral line 41 that has the traveling direction Z of the light spot as the rotational center.

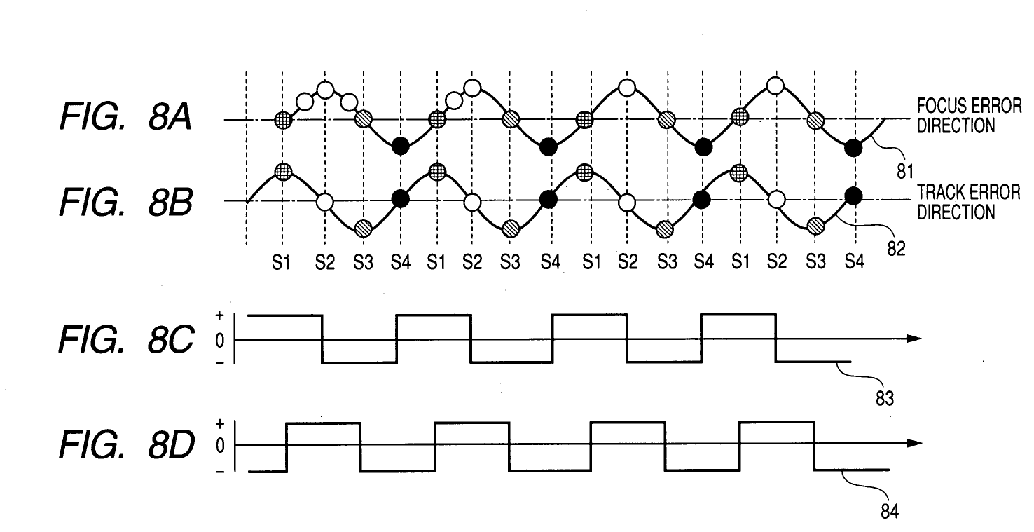

FIG. 8A illustrates a spiral line 81 in which the marks are projected on the Y-Z plane, and FIG. 8B illustrates a spiral line 82 in which the marks are projected on the X-Z plane. Both of these projected waveforms 81 and 82 form sinusoidal waves, in which the cycle is equal and the phase is shifted by 90°. The marks 11 through 18 each are placed on the sinusoidal waves thereof. The amplitude of the sinusoidal waves becomes b and a. The displacements of the marks to the directions X and Y from the traveling direction Z of the light spot can be attained by operating the detected signals each at the marks. The well-known synchronous detection is performed for attaining the displacements. Detection signals 83 and 84 as illustrated in FIG. 8C and FIG. 8D are formed by using the waveforms as shown in FIG. 8A and FIG. 8B, and the phases of these signals are mutually shifted by 90°. These detection signals are multiplied by the signals detected from the marks each being the output of the preamplifier 116 in FIG. 3 or FIG. 5, thereby detecting the X-direction error and the Y-direction error.

The method of using the synchronous detection will be described in detail. The synchronous detection waveforms 83 and 84 are generated as the light spot travels. For detecting the track error signal, the method includes: passing a signal S(t) expressing the time variation that the above marks give to the readout signal through a band-pass filter that passes only the wobble frequency, extracting only the wobble frequency components, multiplying the above frequency components by the synchronous detection waveform 83, and passing the result by the multiplication through a low-pass filter of which cut-off frequency is lower than the repetitive frequency of the synchronous detection waveform. For detecting the focus error signal, the method includes: multiplying the synchronous detection waveform 84 by the signal S(t) expressing the time variation that the above marks give to the readout signal, and passing the result by the multiplication through the low-pass filter of which cut-off frequency is lower than the repetitive frequency of the synchronous detection waveform.

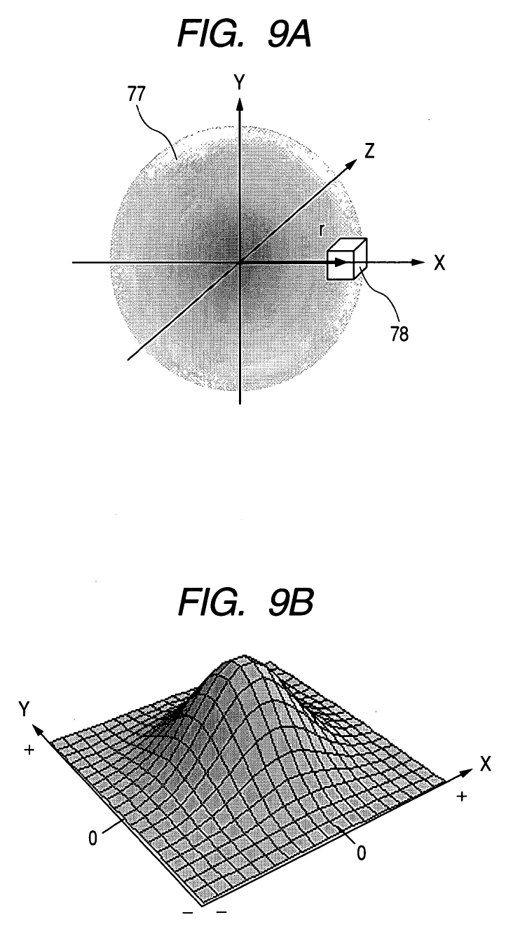

The signal detected by the marks will be described in detail with reference to FIG. 9A and FIG. 9B. In FIG. 9A, a light spot 77 is assumed to be at the center of the three-dimensional coordinate composed of X-axis, Y-axis, and Z-axis. When a mark 78 is located at a position r on the X-axis, the variation that the mark 78 gives to the readout signal by the light spot 77 is a function that depends only on the distance from the center of the light spot 77 to the mark 78, which shows a single-peaked characteristic as shown in FIG. 9B. That is, the variation becomes a maximum level when the distance r is zero, simply decreases as the distance r increases and the intensity of the light spot decreases, and becomes zero in the end.

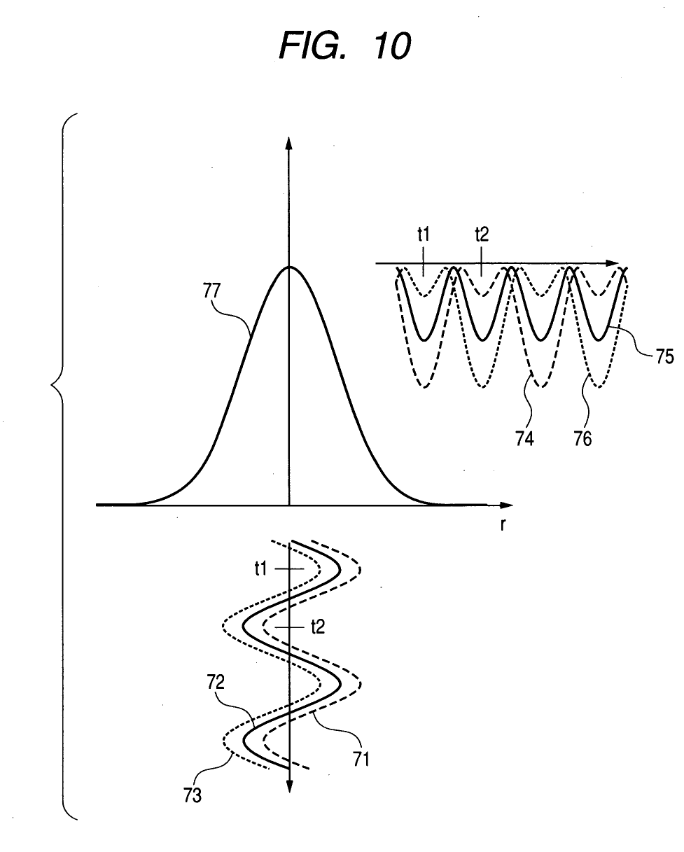

FIG. 10 typically illustrates the detected waveforms of the readout signal, when the light spot travels and the distance r from the center of the light spot to the mark varies in a sinusoidal form. As the relative distance r varies sinusoidally, distances 71, 72, and 73 vary as the center position drifts; and, the variation that the mark gives to the readout signal is given by varied signal waveforms 74, 75, and 76 corresponding to the distances 71, 72, and 73. Here, the distance r becomes the maximum at a timing t1 or t2, and it becomes the minimum between the timings t1 and t2. Viewing the varied signal waveforms, when the relative distance variation is zero at the center position as the distance 72, the detection signal contains only double the frequency of the wobble frequency, and the wobble frequency components are zero. Accordingly, the output becomes zero, when the multiplication of the synchronous detection waveforms and the output from the band-pass filter passes through the low-pass filter. When the center position is on the positive side, the signal variation at the timing t1 is smaller than that at the timing t2, and the frequency components of the wobble frequency becomes increased in the detection signal, and the phase of the frequency components becomes coincident to that of the wobble frequency. Therefore, the output becomes positive, when the multiplication of the synchronous detection waveforms and the output from the band-pass filter passes through the low-pass filter. When the center position is on the negative side, the signal variation at the timing t1 is larger than that at the timing t2, and the frequency components of the wobble frequency becomes increased in the detection signal, and the phase of the frequency components becomes reverse to that of the wobble frequency. Therefore, the output becomes negative, when the multiplication of the synchronous detection waveforms and the output from the band-pass filter passes through the low-pass filter. For knowing the center position, to detect the output attained by that the multiplication of the synchronous detection waveforms and the output from the band-pass filter passes through the low-pass filter will give the magnitude and direction of the center drift of the light spot against the vibration center of the mark whose position varies sinusoidally.

Accordingly, marks are provided on a virtual sinusoidal waveform of the amplitude a in a plane formed in the X-axis direction (radial direction of the track) perpendicular to the traveling direction (Z-axis direction) of the light spot. And if the spot drifts in the radial direction of the track, the relative distance r between a mark and the spot center will vary, and the variation that the mark gives to the readout signal varies as shown in FIG. 9B. To perform the synchronous detection will detect the drift and direction of the light spot in the radial direction of the track, namely, the tracking error signal.

In the same manner, marks are provided on a virtual sinusoidal waveform of the amplitude b in a plane formed in the Y-axis direction (optical axis direction) perpendicular to the traveling direction (Z-axis direction) of the light spot. And if the spot drifts in the radial direction of the track, the relative distance r between a mark and the spot center will vary, and the variation that the mark gives to the readout signal varies as shown in FIG. 9B. To perform the synchronous detection will detect the drift and direction of the light spot in the optical axis direction of the track, namely, the focus error signal. If the phase of the sinusoidal wave of the amplitude a is put into the orthogonal relation with the phase of the sinusoidal wave of the amplitude b, the focus error signal and the tracking error signal will be detected separately.

The control area that generates the control signal can be placed on the circumference of the disk discretely with a certain interval. It is preferred from the following characteristic of the servo system that the control area should be placed at about 1000 points in one rotation of the disk. If the detection interval of the control signal is short, it will enhance the response of the servo system as well as reduce the detection error. If the interval is further shortened so as to join the control area continuously, it will further enhance the characteristic of the servo system.

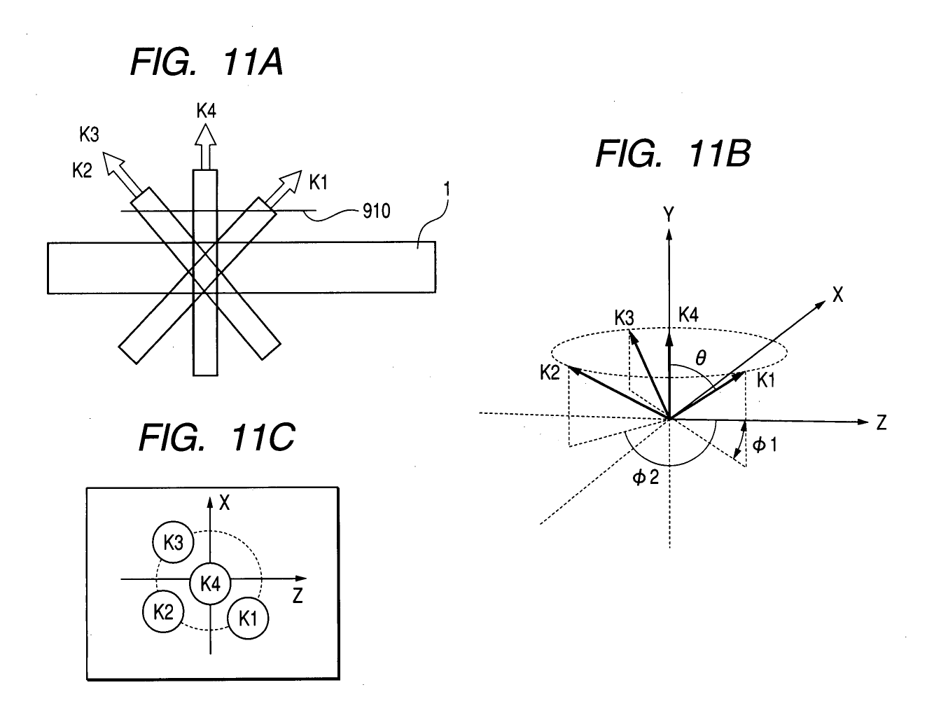

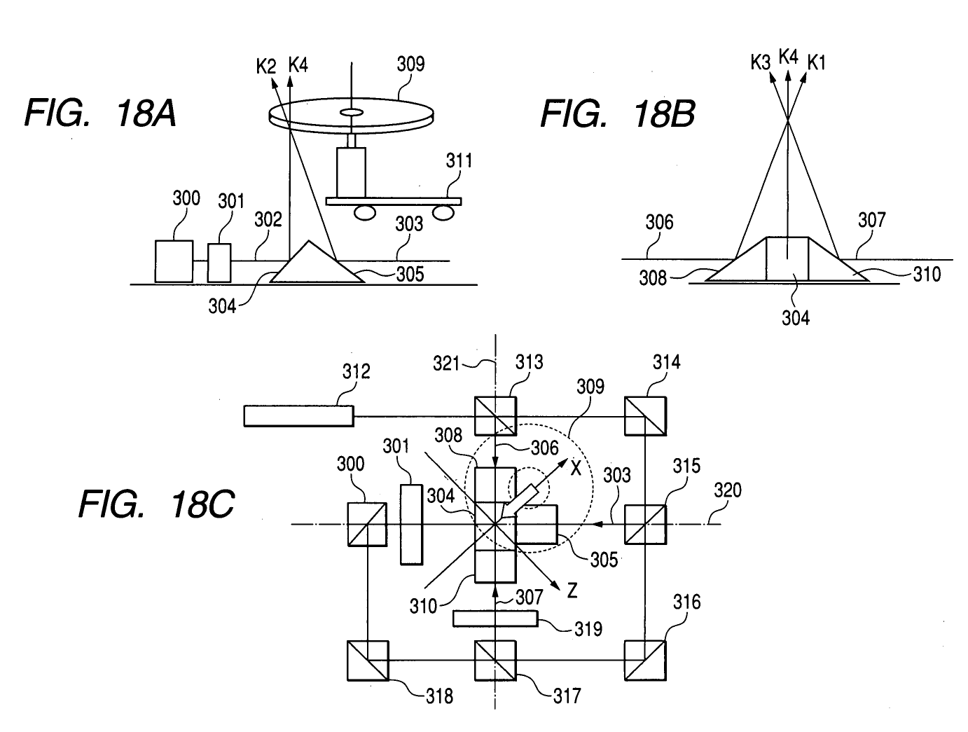

The method of forming the control area will be described with FIG. 11 and FIG. 18. Four beams K1, K2, K3, and K4 are irradiated to the three-dimensional disk 1 as shown in FIG. 11A. The three beams K1, K2, and K3 are crossed in the three-dimensional disk 1, and the remaining beam K4 is made to fall vertically on the three-dimensional disk 1. If the vectors of the beams are expressed by the polar coordinate as shown in FIG. 11B, the vectors K1, K2, and K3 have the same polar angle θ, reside in a conical surface that has the origin as the vertex and the Y-axis as the main axis, the vertical angle of which is 2θ. The azimuths of these vectors are shifted by π/2 each. The vector K4 is in parallel to the Y-axis, and the polar angle and the azimuth thereof are zero.

If the four beams are viewed on a plane 901 as shown in FIG. 11A, they will be observed as shown in FIG. 11C. In order to form the light spots in this manner, the optical system as shown in FIGS. 18A to 18C is used. FIG. 18C is a chart in which the optical system is viewed from the top. FIG. 18A is a cross-sectional view taken on a line 320, and FIG. 18B is a cross-sectional view taken on a line 321. The light beam emitted from a laser 312 is split by a prism 313 to advance to an optical path 306 and to a prism 314. The beam reflected by the prism 314 is split by a prism 315 to advance to an optical path 303 and to a prism 316. The beam reflected by the prism 316 advances to a prism 317, which is split by the prism 317 to advance to an optical path 307 and to a prism 318. The beam from the prism 318 is reflected by a prism 300 to advance to a reflective plane 304. On the optical path 307 and 302 are placed optical elements 301 and 319 that vary the phase of the light beam. As the optical elements, liquid crystal or electro-optic crystal or the like can be used.

In FIG. 18A showing the section on the line 320, the beam reflected by the prism 300 advances on the optical path 302 to penetrate through the optical element 301, where the beam experiences a phase variation, and is reflected by the reflective plane 304 to advance upright toward a disk 309, thus forming the light beam K4. The beam coming along the optical path 303 is reflected by a reflective plane 305, and forms the light beam K2 that crosses with the light beam K4 in the disk 309.

On the other hand, in FIG. 18B showing the section on the line 321, the beam coming along the optical path 306 is reflected by a reflective plane 308, and forms the light beam K1, which crosses with the light beams K3 and K4 in the disk 309. The beam coming along the optical path 307 is reflected by a reflective plane 310, and forms the light beam K3. As mentioned above, the beam coming along the optical path 302 is reflected by the reflective plane 304, forms the light beam K4, and crosses with the other light beams in the disk 309 with the relation as shown in FIG. 11.

FIG. 12 illustrates a cubic diagram of a three-dimensional lattice that is formed in the three-dimensional optical disk 1 by the optical system as shown in FIG. 11 and FIG. 18. The shape at a lattice point represents the range of a certain magnitude of interference intensity. The three-dimensional lattice formed is a combination of two body-center cubes 921 and 922. The cube 921 is formed of lattice points 925, 926, 927, 928, and 934. The lattice of the cube 922 is located at the body center of the cube 921, and the lattice 930 of the cube 921 is located at the body center of the cube 922. In a plane 923 including the lattice points 927, 928, 929, and 930, the interference intensity becomes as shown in FIG. 13A and FIG. 13B on a section in parallel to the x-y plane. The bright spot shows a high level of the interference intensity. The lattice points of the body-center cubes 921 and 922 overlap each other, and two cubes with equal lattice interval seem to appear alternately toward the Z-axis direction. Such a three-dimensional lattice is achieved under the condition of θ=50°, φ1=0°, φ2=90°, and the intensity of four beams being equal.

To move the lattice in the Y-axis direction needs to vary the phase of the wave front of the beam K4 with the phases of the other beams fixed. And, to move the lattice in the X-axis direction needs to vary the phase of any one of the beams K1, K2, and K3. As the three-dimensional optical disk 1 moves in the Z-axis direction, the three-dimensional lattices are recorded while the positions thereof move in the circumferential direction. When the light spots travel through the lattices thus formed along the Z-axis, the lattices wobble to the light spots.

In order to make the lattices move spirally, it is needed to bring the wobble period at which the wave front varies in the Y-axis direction into coincidence with the wobble period at which the wave front varies in the X-direction and to shift the wobble phase by 90° to each other. With this construction provided, as the three-dimensional optical disk 1 moves in the Z-axis direction, the lattices are recorded while the lattice positions move spirally. When the light spots travel through the above lattices along the Z-axis, the lattices wobble spirally to the light spots. Taking this into consideration, in FIG. 18, the optical element 301 is made to shift the phase of the light beam in the Y-axis direction of the disk, and the optical element 319 is made to shift the phase of the light beam in a plane formed by the X-axis and Y-axis of the disk. By shifting the phase relation by 90° between an electric signal that controls the phase shift by the optical element 301 and an electric signal that controls the phase shift by the optical element 319, the control mark group can be formed, as shown in FIG. 14.

FIG. 14 is a chart in which the disposition of the control mark group is illustrated by means of the triangular method. The round mark represents the lattice point. Plural lattice points spirally travel in the Z-direction around a center line 962. The projection to the x-y plane of the spiral line around the center line 962 is a circle 965. The projection of the spiral line to the z-x plane is a sinusoidal wave 963 and the projection of the same to the z-y plane is a sinusoidal wave 968; these two sinusoidal waves have the same cycle, but each has different phases shifted by 90°, which are orthogonal to each other. And, plural lattice points make a spiral movement around a center line 971. The projection to the x-y plane of the spiral line around the center line 971 is a circle 966. The projection of the spiral line to the z-x plane is a sinusoidal wave 964, and the projection of the same to the z-y plane is a sinusoidal wave 967. To use these lattice points as the marks in the control signal detection area will detect the focus error signal and the track error signal.

The principle on which the positioning of the spot is performed by the mark to read/write information will be described with FIG. 15. The lattice point resides anywhere on the projected circles 965, 976, 977, and 978 of the spiral line to the x-y plane. The lattice point resides anywhere on the projected circle 966 as well. The reading/recording of information is performed by using the three-dimensional spatial area 204 between the lattice points as one information recording block. There are several methods of recording information in the information recording area 204. One of them is illustrated in FIG. 16, and another one is illustrated in FIG. 17.

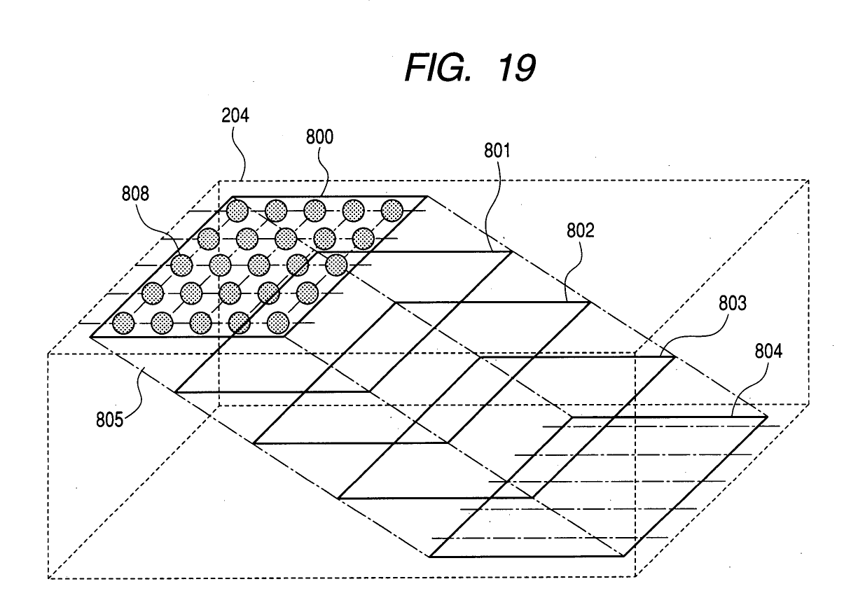

Further, the method of recording data three-dimensionally in the information recording area 204 is illustrated in FIG. 19. In this method, the optical element 49 scans a light spot group 808 in which the light spots are arrayed two-dimensionally with the relative positions fixed along a line 805 in the optical axis direction, and as a plane 800 reaches a plane 804, the scanning turns back to repeat the same operation. The three-dimensional information is recorded at one time with a plural-spots group on a two-dimensional plane as a page, the two-dimensional plane is scanned in the optical axis direction, and thus the information is recorded three-dimensionally in the three-dimensional information recording area 204. Thus, in the information recording area 204 are formed the marks at the positions corresponding to the lattice points of the preset three-dimensional lattices. In consequence, the data are recorded with a predetermined interval by using the information recording area 204 as one block, between the control areas of the information track 27 in the three-dimensional optical disk.

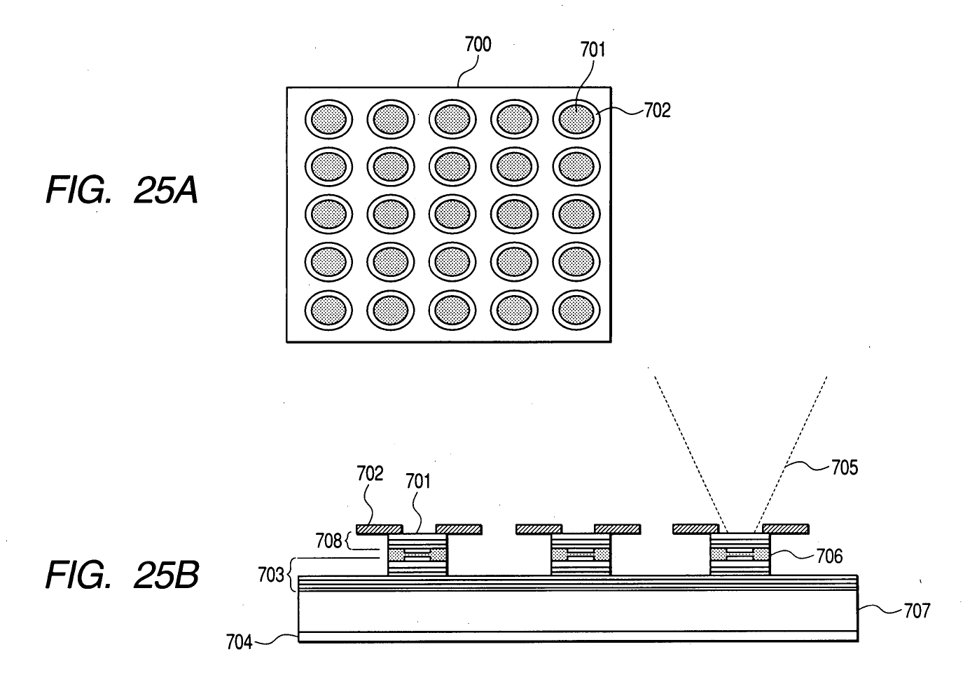

In order to implement this method, a two-dimensionally arrayed semiconductor laser 700 is necessary, the plan view of which is shown in FIG. 25A. As a two-dimensional arrayed laser, the vertical-cavity surface-emitting laser (VCSEL) is manufactured and available on the market, the sectional structure of which is shown in FIG. 25B. Over a substrate 707 of III to V group compound semiconductor such as AlGaAs are formed a multi-layer 708 of P-DBR (P-type Distribution Bragg Reflection), a layer containing aluminum as a major composition, a laser active layer 706, and a multi-layer 703 of N-DBR (N-type Distribution Bragg Reflection), by means of the vapor phase epitaxy. An N-type electrode 704 and a P-type electrode 702 are fixed, and a current is flown longitudinally to make a vertical laser oscillation. A laser beam 705 is taken out from a window 701 made by piercing the electrode 702. To modulate the current will modulate the laser beam emitted.

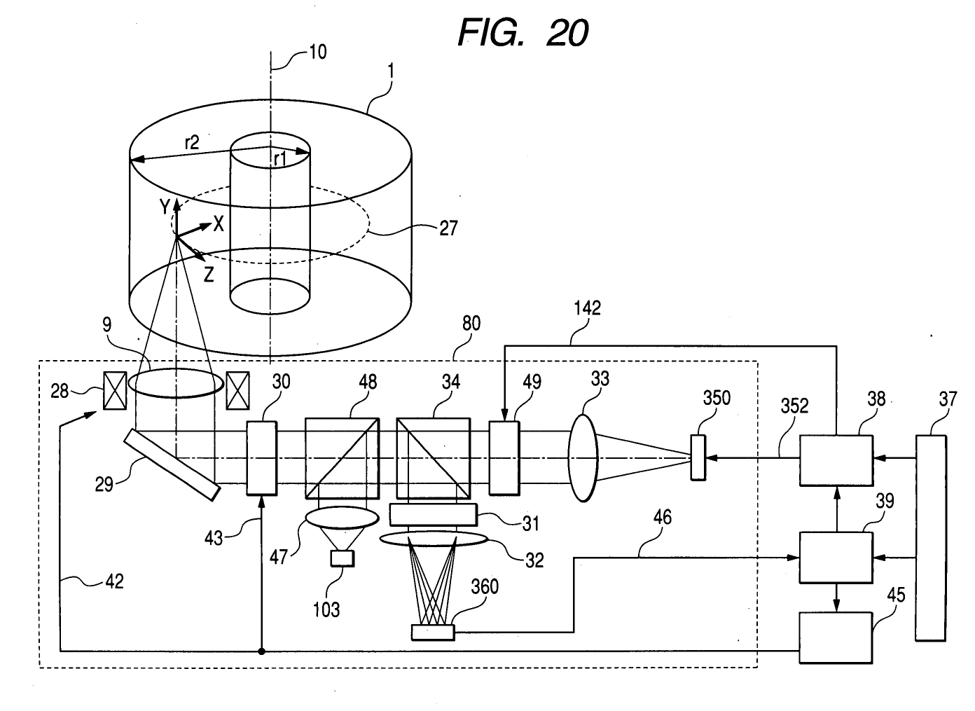

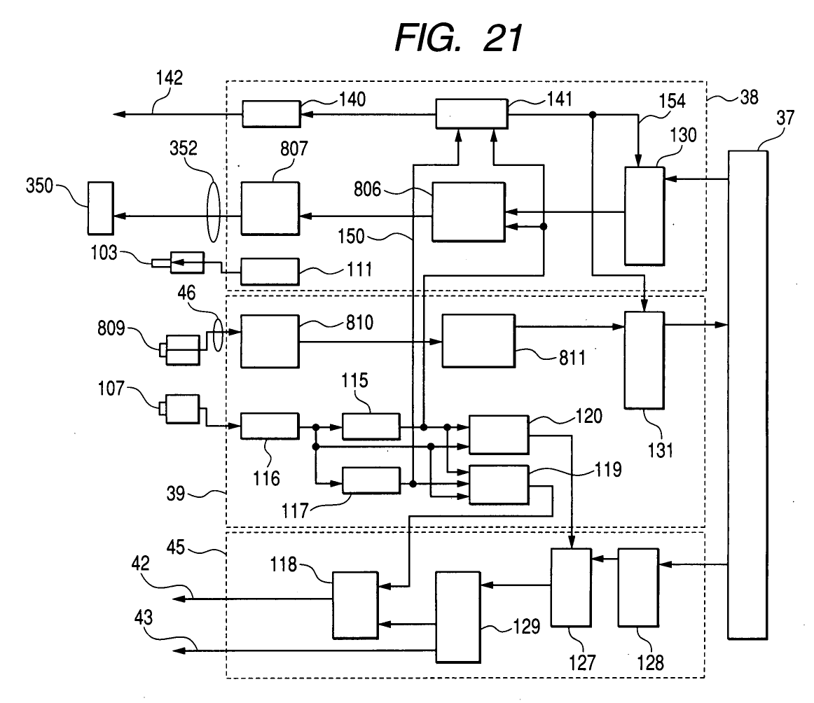

The operation of the read/write circuit will be described further in detail with FIG. 20 and FIG. 21. A light source 350 is composed of plural light sources, for example, a two-dimensionally arrayed semiconductor laser. The light beams from the light sources each are condensed on the planes 800, 801, 802, 803, and 804 that are formed by dividing the information recording area (data block) 204 in the depth direction, as the two-dimensional spot group 808. Therefore, as the position of the light spot 23 for tracking is determined, the positions of the other light spots for reading/writing information are automatically located from the relation of a specified array. The beams emitted from the light source 350, being collimated by the coupling lens 33, penetrate through the optical element 49 that moves the light spots in the optical axis direction (that adds parabolically inflected modulations to the wave fronts and varies the focus positions of the focused light spots along the optical axis), and the objective lens 9 condenses the beams in the disk 1. The light source 103 is supplied with a dc current through the driver circuit 111 so as to irradiate a constant amount of light. The light beams emitted from the light source 103 are reflected on the disk, and are condensed by the light receiver 107 mounted on an optical detector 360. The photo-electric current 46 is converted into a voltage by the preamplifier 116, which is inputted to the clock generation circuit 115, the data discrimination circuit 120, and the area detection circuit 117.

The area detection circuit 117 detects the control areas 21 and 22 while discriminating them from other areas, and inputs the signal 150 indicating the control area to the circuit 119 for generating control information. The circuit 119 generates the track error signal and the focus error signal, and these signals are inputted to the drive circuit 118 that drives the two-dimensional actuator 28. On the other hand, the data discrimination circuit 120 detects the track address signal, which is inputted to the circuit 127 for comparing address information. The circuit 127 compares the above track address signal and the signal outputted from the register 128 that temporarily stores the address orders from the host controller 37. The circuit 129 for generating the signals that control the light spots sends out the signal for controlling and driving the two-dimensional actuator 28 to the drive circuit 118, and sends out the signal 43 for compensating the aberration caused by the movement of the actuator 28. The register 130 receives the user data sent out from the host controller 37, and stores the data as the three-dimensional information. The register 130 inputs a two-dimensional data to a two-dimensional modulation circuit 806 according to the signal 154 that moves the spot group in the optical axis direction. The two-dimensional modulation circuit 806 performs the two-dimensional modulation on the basis of the output from the clock generation circuit 115. The output from the modulation circuit 806 is inputted to a drive circuit 807 for driving the two-dimensionally arrayed laser, which performs the intensity modulation to the light source 350 of the two-dimensionally arrayed laser.

The reading/writing operation of the information will further be described with FIG. 19. The optical element 49 moves the light spot group 808 in the optical axis direction, and scans the spot group 808 along the line 805 in the optical axis direction. As the plane 800 reaches the plane 804, the plane is returned to the original position to repeat the same scanning. The three-dimensional information is recorded at one time with a plural-spots group on a two-dimensional plane as a page, the two-dimensional plane is scanned in the optical axis direction, and thereby the information is recorded three-dimensionally in the three-dimensional information recording area 204. The data are recorded with a predetermined interval by using the information recording area 204 as one block, between the control areas of the information track 27 in the three-dimensional optical disk. In order to perform such a recording, the register 130 stores the recorded data for the planes 800, 801, 802, and 803 each by the two-dimensional planes each at specified timings, and sends out the data pairs to the two-dimensional modulation circuit 806 at each scanning timing. As a two-dimensional modulation method can be cited the method disclosed in the JPB, No. 3149455.

The scanning control circuit 141 for controlling the scanning of the light spots receives the signal 150 indicating the control area and the clock signal, and generates drive waveforms for scanning the spots in the focus direction. The scanning control circuit 141 sends out the drive waveforms to the drive circuit 140, and at the same time sends out the timing signal 154 indicating the presence of the data planes to be read or written synchronously with the drive waveforms to the registers 130 and 131. The register 130 outputs a pair of two-dimensional recorded data to the modulation circuit 806 according to the timing signal 154.

For reading out recorded data, the light spot 23 for tracking is positioned on the information track 27, and the spot group 808 for reading out information is positioned on the plane 800 having the recorded data recorded. The reflected light beams from the marks are each condensed on a receiver group 809 mounted on the optical detector 360. The photo-electric currents each are converted into voltages by a preamplifier group 810. The data discrimination circuit group 811 detects and two-dimensionally demodulates the above converted voltages based on the clock generated by the clock generation circuit 115. The results are stored in the register 131 and are sent to the host controller 37. The register 131 stores two-dimensional data pairs outputted in parallel from the data discrimination circuit group 811 at each time of scanning, as the three-dimensional data. The register 131 transforms the format of the stored data into that of the user data before sending out the data to the host controller 37.

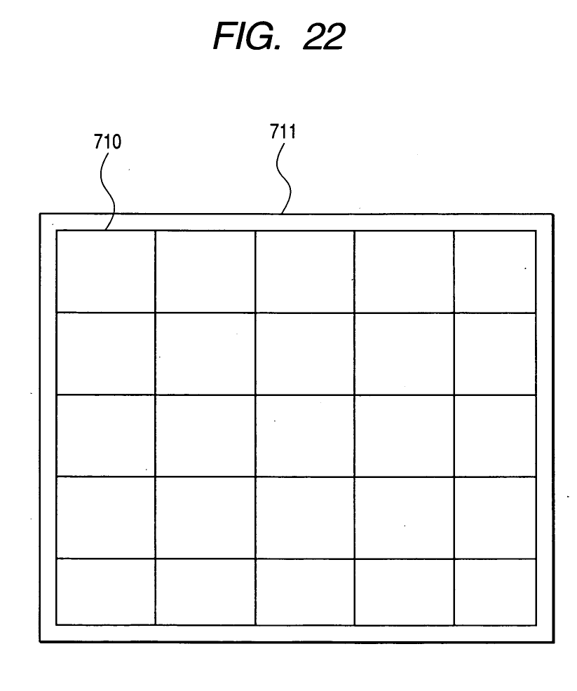

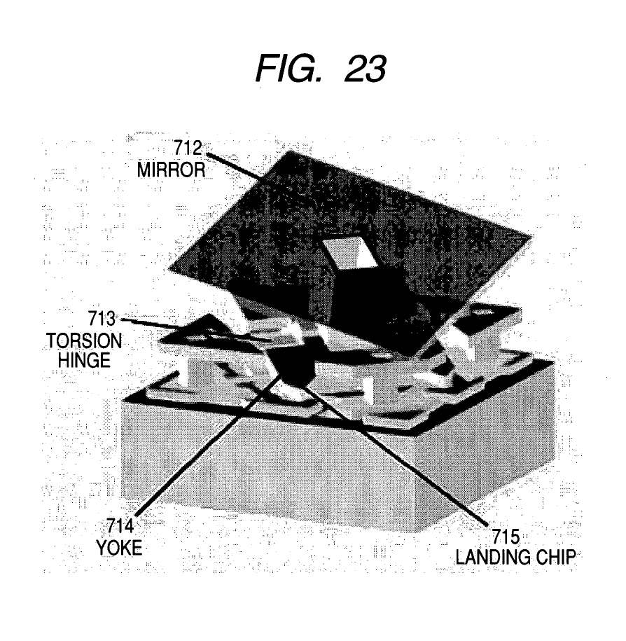

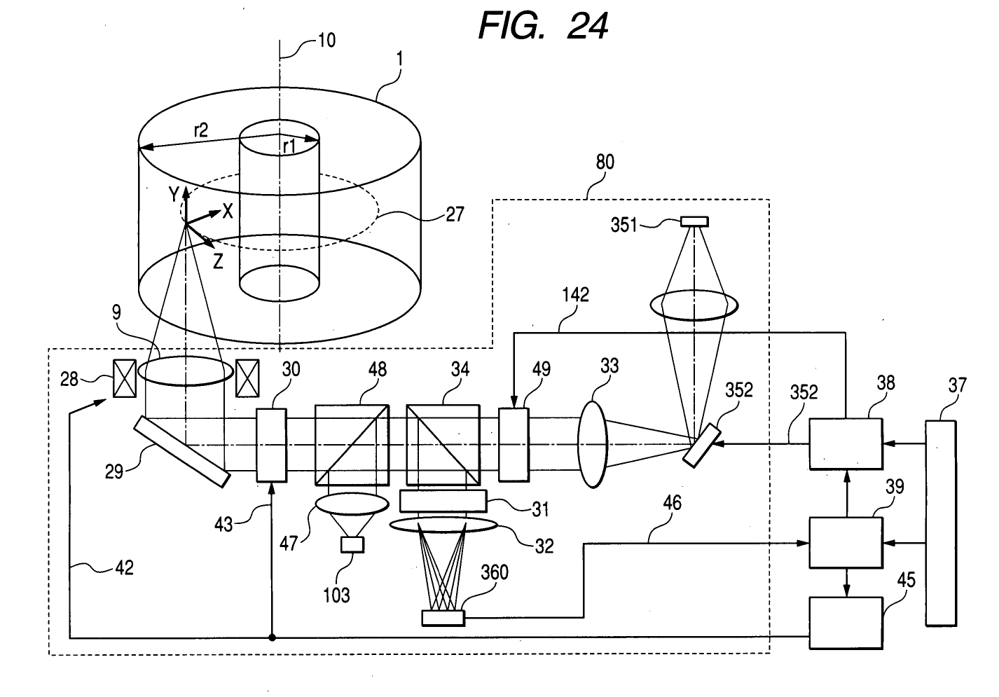

Another embodiment will be described with reference to FIG. 22, FIG. 23, and FIG. 24. This embodiment employs a digital mirror instead of the two-dimensionally arrayed laser. FIG. 22 is a schematic diagram of a digital mirror, FIG. 23 is a schematic chart of compositions of the digital mirror, and FIG. 24 is a schematic diagram of the three-dimensional information reading/writing device using the digital mirror.

As the schematic diagram of a digital mirror is illustrated in FIG. 22, the digital mirror is a reflective optical modulation device, in which the mechanical function, the optical function, and the electrical function are integrated into one semiconductor chip 710 of a CMOS SRAM by taking full advantage of the wafer process technique and the plasma etching technique and so forth.

As shown in FIG. 23, the digital mirror is formed into the four layers of: from the top, a mirror, an upper frame and hinge, a metal, and a CMOS part. In the mirror, multiple square aluminum mirrors are arrayed with a same pitch. The mirror is made to vary the orientation to face to two directions according to the memory address output. When it takes one of the two directions, the mirror reflects the beams from the light source to such a direction that the reflected beams advance to the lens 33. The mirror and yoke fixed by a thin twist hinge rotate until they are adhered to a landing ground by the electrostatic attraction acting between the memory cell and themselves. A spring chip is formed on the end of the yoke, and this chip stores and expels the electrostatic attraction energy to give a secure rotational operation to the mirror. By this construction, the intensity control of the light beams irradiated to the disk can be performed, as already mentioned in the two-dimensionally arrayed laser; accordingly, the reading/writing circuit described with FIG. 21 can be used. It is only needed to drive the digital mirror according to the output from the drive circuit 807 for driving the two-dimensionally arrayed laser. As shown in FIG. 24, the construction is made such that, during recording, a light source 351 of a semiconductor laser emits light beams with a constant light power, a lens introduces the emitted beams to a digital mirror 352, and the reflected beams by the digital mirror 352 advance to fall on the coupling lens 33. The optical system other than the above is the same as FIG. 20.

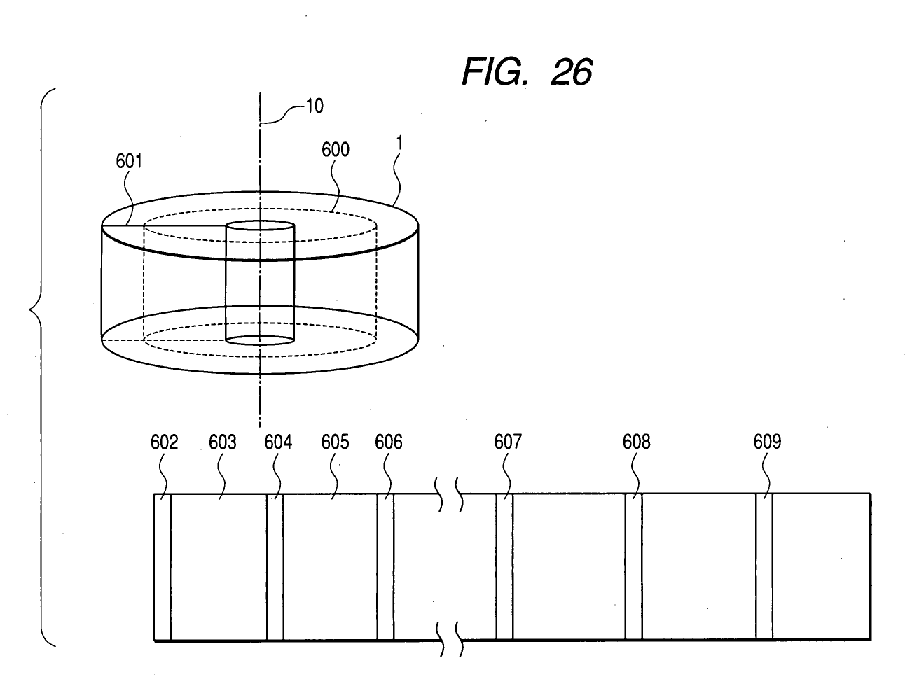

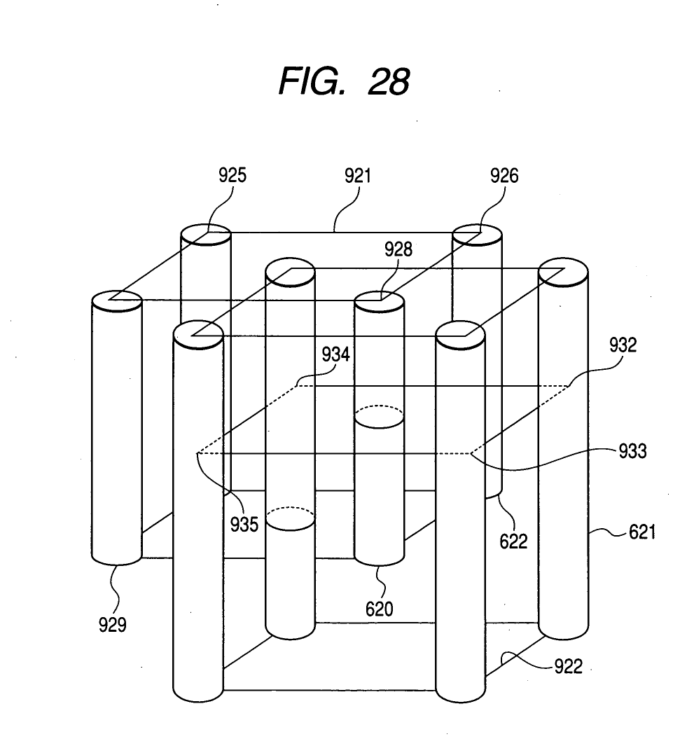

The address information requires the information on the following directions: the radial direction (X-axis) of the disk, the optical axis direction (Y-axis), and the circumferential direction (Z-axis) of the disk. And, a circumference 600 for one turn that starts at the radius 601 of the disk 1 is unwound, as shown in FIG. 26. An area 602 where the radius 601 crosses with the circumference 600 is defined as the reference for the reading/writing operation. The reference is needed to be capable of detecting the light spots, although it does not control the light spots. Because of this, a structure is made as shown in FIG. 28. That is, the lengths of the marks in FIG. 12 are extended to the optical axis direction; the marks 928 and 930 are coupled to make a bar 620, and the marks 926 and 931 are coupled to make a bar 622. And, the mark 932 is extended to make a bar 621.

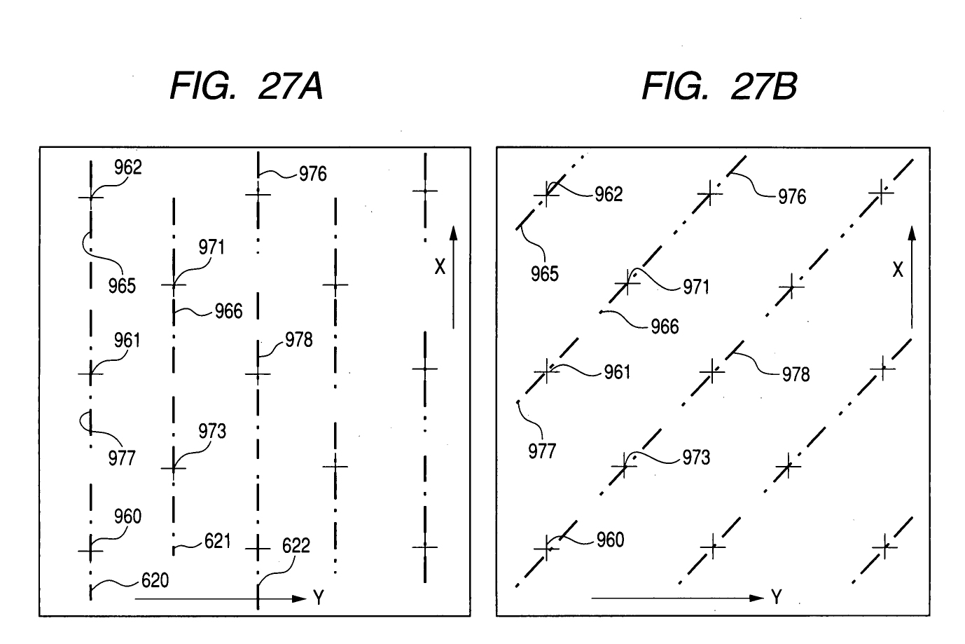

In order to extend the marks to make the bars, the waveforms are varied which drive the optical elements 301 and 319 that vary the phases of the light beams. In order to make the mark into a bar, the oscillation frequency is increased compared to the rotation speed of the disk, and the phase shift of the light beams in the optical axis direction is set to an extent that varies the phase of one wavelength, so that the interference marks overlap each other. Here, the phase shift of the light beams is made zero in the radial direction of the disk. If this state is shown with such a chart as the X-Y section in FIG. 14, it will be as shown in FIG. 27A. The trajectories of the marks 977, 965, 966, 976, and 978 that vary spirally around the center points 960, 961, 962, 971, and 973 become lines, and the marks join each other to make the bars 620, 621, and 622. If a light spot passes through the above area being out of focus, since the marks are present with an equal interval, it will become possible to easily generate the clock signal necessary for the processing of the control signal. Since this shape is continuous in the focus direction, it is convenient to the spot being out of focus; however, since the bars are discrete in the radial direction of the track, it is likely to be subjected to the eccentricity.

Accordingly, it is desirable to slant the bars both in the optical axis direction and in the radial direction, as shown in FIG. 27B. To perform this only needs to increase the oscillation frequency compared to the rotation speed of the disk, and to drive the optical elements 301 and 319 in a manner that the phase of the light beams in the optical axis direction and the phase of the light beams in the radial direction vary synchronously with such an equal extent as the marks overlap. If the above is implemented, no matter how is the initial condition of the light spots, it will be possible to correctly detect the clock information. It is necessary to provide the above areas in the plane of the radius 601, at one place at least in the circumferential direction. It is recommendable to provide plural synchronous areas 604, 606, 607, 608, and 609 for attaining easy synchronization with the clock. Accordingly, it is desirable to use FIG. 27A for distinguishing the areas from the area 602. The data recording areas are present in the areas 603 and 605, which are sandwiched between the synchronous areas.

Also in order for the access in the radial direction of the disk, the waveforms are varied which drive the optical elements 301 and 319 that vary the phases of the light beams. During forming the marks for controlling in FIG. 18, the frequency for varying the phase of the light beams is varied by each rotation of the disk. Thereby, to detect the frequency will find the position of the radius.

The process for accessing a specific data area will be described according to this embodiment. First, the disk is fit into the spindle, and is rotated. The light spot is driven to approach the disk from one direction, reaches the disk, and detects the area 602. Thereby, the clock is pulled in, the clock is formed, and the focus error signal is generated. Driving the light spot to one direction further, the layer of the light spot passing through is detected from the focus error signal, and it is judged as to which layer it resides in. When it reaches a predetermined layer, the wobble frequency of the control area is detected in the radial direction, and it is judged as to which place it resides in the radial direction. When it reaches a predetermined radial position, it travels one track by one track by using the tracking error signal. When it reaches a predetermined track, it detects the area 602. From this, the number of the synchronous areas or the rotation time is measured, and the light spot is positioned at a predetermined recording area.

In addition, in above embodiment, the first wavelength for the tracking light spot and the second wavelength for recording and/or reproducing light spot are different wavelength. However the same wavelength of the first wavelength and the second wavelength can be used.

What is claimed is:

1. A three-dimensional information recording method for recording information in a three-dimensional optical disk in which plural control areas having control information for guiding light spots recorded are arranged along an information track three-dimensionally with a predetermined interval, comprising the steps of:
reading out the control information by using a tracking light spot with a first wavelength, and positioning the tracking light spot to the information track by using the control information read out; and
recording information three-dimensionally by recording marks at lattice points of a three-dimensional lattice set in an information recording area between adjoining two control areas along the information track, by using a recording light spot with a second wavelength, of which relative positional relation to the tracking light spot is variable.

2. A three-dimensional information recording method according to claim 1, wherein the recording light spot is formed with one light spot, and the marks are recorded by scanning the one light spot at the lattice points of the three-dimensional lattice while turning on and off the one light spot according to recorded information.

3. A three-dimensional information recording method according to claim 1, wherein the recording light spot is formed with plural light spots of which relative positional relation is fixed, and the marks are recorded by scanning the plural lattice spots at the lattice points of the three-dimensional lattice while turning on and off the plural light spots according to recorded information.

4. A three-dimensional information recording method according to claim 1, wherein the recording light spot is formed with plural light spots arrayed two-dimensionally, of which relative positional relation is fixed, and the marks are recorded by scanning the plural light spots at the lattice points of the three-dimensional lattice while turning on and off the plural light spots according to recorded information.

5. A three-dimensional information recording method according to claim 1, wherein the control areas are arranged on a rotational circumference of the three-dimensional optical disk with a virtually equal interval, and are arranged also in the thickness direction of the disk with a virtually equal interval.

6. A three-dimensional information recording method according to claim 1, wherein the control areas include at least one mark and the marks are arranged to surround the information track spirally.

7. A three-dimensional information readout method that reads out information from a three-dimensional optical disk in which plural control areas having control information for guiding light spots recorded are arranged along an information track three-dimensionally with a predetermined interval, and information is recorded three-dimensionally by marks recorded at lattice points of a three-dimensional lattice set in an information recording area between adjoining two control areas along the information track, comprising the steps of:
reading out the control information by using a tracking light spot with a first wavelength, and positioning the tracking light spot to the information track by using the control information read out; and
reading out information from the information recording area by using a readout light spot with a second wavelength, of which relative positional relation to the tracking light spot is variable.

8. A three-dimensional information readout method according to claim 7, wherein the readout light spot is formed with one light spot, and the marks are read out by scanning the one light spot at the lattice points of the three-dimensional lattice.

9. A three-dimensional information readout method according to claim 7, wherein the readout light spot is formed with plural light spots of which relative positional relation is fixed, and the marks are read out by scanning the plural light spots at the lattice points of the three-dimensional lattice

10. A three-dimensional information readout method according to claim 7, wherein the readout light spot is formed with plural light spots arrayed two-dimensionally, of which relative positional relation is fixed, and the marks are read out by scanning the plural light spots at the lattice points of the three-dimensional lattice

11. A three-dimensional information readout method according to claim 7, wherein the control areas include at least one mark and the marks are arranged to surround the information track spirally.

12. A three-dimensional information recording method according to claim 1, wherein the first wavelength and the second wavelength are substantially same.

13. A three-dimensional information recording method according to claim 7, wherein the first wavelength and the second wavelength are substantially same.
